(19) United States
(12) Patent Application Publication
(10) Pub. No.: US 2026/0296355 A1
(43) Pub. Date: Oct. 1, 2026

(54) SIDE AIRBAG DEVICE

(71) Applicants: TOYODA GOSEI CO., LTD., Kiyosu-shi (JP); HONDA MOTOR CO., LTD., Tokyo (JP)

(72) Inventors: Takayuki UMEYAMA, Aichi (JP); Tomohiro IWATA, Aichi (JP); Takenori OZAKI, Aichi (JP); Takahiro KOJIMA, Aichi (JP); Yusuke CHIDA, Tokyo (JP); Makoto NODA, Tokyo (JP); Daiki NAKATSU, Tokyo (JP); Koji SANO, Tokyo (JP)

(21) Appl. No.: 19/550,507

(22) Filed: Feb. 26, 2026

(30) Foreign Application Priority Data
Mar. 27, 2025 (JP) 2025-052785

(51) Int. Cl. B60R 21/231; B60R 21/2338

(52) U.S. Cl. CPC B60R 21/23138; B60R 21/2338; B60R 2021/23146; B60R 2021/23388

(57) ABSTRACT

A side airbag device has an airbag and a tether. The airbag includes a first bag portion fixed to a seat back, and a second bag portion displaced in a direction away from the first bag portion when the airbag is inflated. The tether includes a first tether portion fixed to the first bag portion, and a second tether portion fixed to the second bag portion. A distance between the first tether portion and the second tether portion in a state where the tether is disposed in a planar shape is smaller than a distance between the first bag portion and the second bag portion in a state where the airbag is disposed in a planar shape. The second bag portion, the second tether portion, the first bag portion, and the first tether portion are positioned inside the seat back in a state where the airbag is deployed.

### CROSS-REFERENCE TO RELATED APPLICATIONS

This application is based on and claims priority under 35 USC 119 from Japanese Patent Application No. 2025-052785 filed on Mar. 27, 2025, the entire content of which is incorporated herein by reference.

### TECHNICAL FIELD

The present disclosure relates to a side airbag device.

### BACKGROUND ART

In the related art, there is a far-side airbag device provided in a seat back of a vehicle seat. In the technique disclosed in JP2022-186427A, at a center side of a vehicle, an airbag is fixed, to a side frame portion closer to the center of the vehicle between a pair of side frame portions in a seat back. When an inflation gas is supplied, the airbag is deployed and inflated forward of the seat back while leaving a portion fixed to the side frame portion in the seat back. A front end portion of a tether is connected to a front end of the airbag. A rear end portion of the tether is attached to the side frame portion, to which the airbag is fixed, on a side facing the center of the seat back.

In a state where the airbag is deployed, a front end portion of the airbag is pulled by the tether rearward and in a direction toward the center of the seat back. As a result, the airbag is curved toward an occupant sitting on a seat. At this time, most of the tether is located outside the seat. Further, when the occupant falls toward the tether stretched between the side frame portion and the front end portion of the airbag, in other words, toward the center of the vehicle, the airbag is pulled by the tether and further curved toward the occupant. As a result, an area of the airbag that comes into contact with the occupant increases.

In the technique disclosed in JP2022-186427A, the shape of the airbag at the time of deploying is controlled by bringing the occupant sitting on the seat come into contact with the tether after the inflation of the airbag is started. Therefore, when the airbag is deployed, the airbag may be deployed with an unexpected shape transition due to movement of the occupant.

### SUMMARY OF INVENTION

The present disclosure may be implemented by the following aspects of a side airbag device.

(1) An aspect of the present disclosure relates to a side airbag device disposed in a seat back, the side airbag device having:

an airbag fixed to the seat back in a folded state and configured to be inflated forward from the seat back when the airbag is supplied with a gas; and

a tether configured to restrict a shape of the airbag when the airbag is inflated, in which

the airbag includes:

a first bag portion fixed to the seat back; and

a second bag portion displaced in a direction away from the first bag portion when the airbag is inflated,

the air bag does not include an inflation portion, which is inflated when receiving the gas, in at least a section between the first bag portion and the second bag portion,

the tether includes:

a first tether portion fixed to the first bag portion; and

a second tether portion fixed to the second bag portion,

a distance between the first tether portion and the second tether portion in a state where the tether is disposed in a planar shape is smaller than a distance between the first bag portion and the second bag portion in a state where the airbag is disposed in a planar shape, and

the airbag and the tether are configured such that the second bag portion, the second tether portion, the first bag portion, and the first tether portion are positioned inside the seat back in a state where the airbag is deployed.

In the aspect (1), when an airbag is deployed, displacement of a second bag portion in a direction away from a first bag portion is restricted by a tether. As a result, the airbag at the time of deploying bends with a portion that is not an inflation portion interposed between the first bag portion and the second bag portion, and a shape of the airbag at the time of deploying becomes a curved shape. In a state where the airbag is deployed, the second bag portion, a second tether portion, the first bag portion, and a first tether portion are positioned inside a seat back. Therefore, a portion of the tether that restricts a distance between the first bag portion and the second bag portion is also positioned inside the seat back and does not come into contact with an occupant. Therefore, when the airbag is deployed, a possibility that the airbag is deployed with an unexpected shape transition due to movement of the occupant is reduced.

(2) In the side airbag device according to the aspect (1), the side airbag device further having:

an inflator fixed to a frame of the seat back and configured to supply the gas into the airbag, in which

the first bag portion is disposed between the inflator and the frame, and is fixed to the frame together with the inflator.

According to the aspect (2), the first bag portion is fixed to a frame of the seat back while the first bag portion is interposed between a rigid frame and a rigid inflator. Therefore, when the airbag is deployed, a position of the first bag portion is less likely to move. As a result, shape transition of the airbag when the airbag is deployed is accurately controlled.

(3) In the side airbag device according to the aspect (2), the airbag includes:

an upper portion that is a part of the airbag, and includes an upper end of the airbag in a state where the airbag is deployed; and

a lower portion that is another part of the airbag, and includes a lower end of the airbag in the state where the airbag is deployed, and

the first bag portion and the second bag portion are provided in the lower portion.

According to the aspect (3), the vicinity of a head of the occupant can be effectively protected by an upper portion of the airbag. On the other hand, an upper body of the occupant including the head can be appropriately protected by controlling the shape of the airbag including the upper portion at the time of deploying without impairing a function of protecting the vicinity of the head of the occupant by a lower portion of the airbag.

(4) In the side airbag device according to the aspect (3), the side airbag device further having:

an additional tether configured to restrict a shape of the airbag when the airbag is inflated, in which

the additional tether includes:

a third tether portion fixed to a third bag portion in the upper portion; and

a fourth tether portion fixed to the frame, and

a distance between the third tether portion and the fourth tether portion in a state where the additional tether is disposed in a planar shape is equal to or smaller than a distance between the third bag portion and a portion of the frame where the fourth tether portion is to be fixed in a case of assuming that the airbag is deployed without the additional tether.

According to the aspect (4), when the airbag is deployed, displacement of the upper portion of the airbag with respect to the frame is further restricted by an additional tether. Therefore, when the airbag is deployed, the airbag is deployed in a more stable position and shape.

The present disclosure may be implemented by various aspects other than the above aspects. For example, the present disclosure can be implemented by aspects of a manufacturing method or a design of the side airbag device, a computer program for implementing a method for controlling the side airbag device, and a non-transitory recording medium storing the computer program.

### BRIEF DESCRIPTION OF DRAWINGS

Exemplary embodiment(s) of the present invention will be described in detail based on the following figures, wherein:

FIG. 1 is a view showing a side airbag device 10 according to an embodiment;

FIG. 2 is a view showing a state where an airbag 100 of the side airbag device 10 is deployed;

FIG. 3 is a view showing a relationship between the airbag 100, and a first tether 510 and a second tether 520;

FIG. 4 is an enlarged view showing the vicinity of the first tether 510;

FIG. 5 is a view showing a case 600 and a support plate 700;

FIG. 6 is a view showing shape transition of the airbag 100 when the airbag 100 is deployed;

FIG. 7 is a view showing shape transition of the airbag 100 when the airbag 100 is deployed;

FIG. 8 is a view showing shape transition of the airbag 100 when the airbag 100 is deployed; and

FIG. 9 is a view showing shape transition of the airbag 100 when the airbag 100 is deployed.

### DESCRIPTION OF EMBODIMENTS

### A. Embodiment

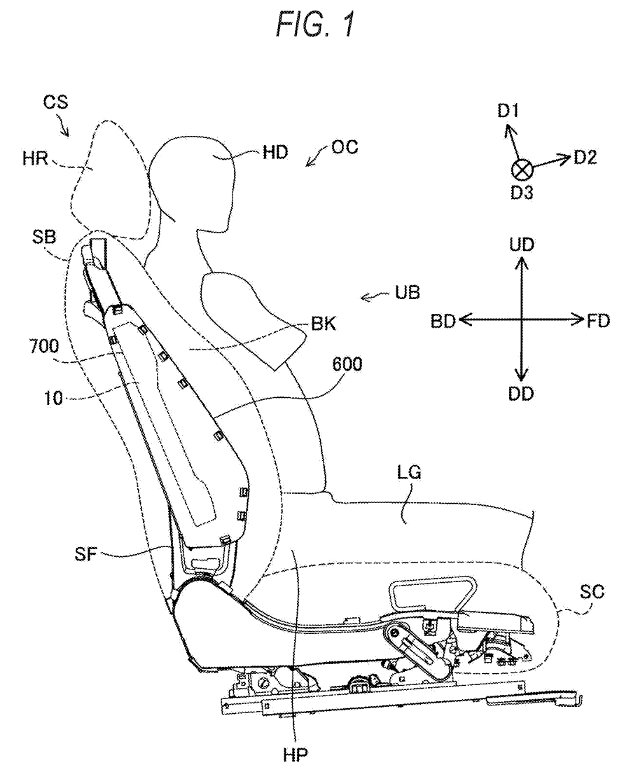

FIG. 1 is a view showing a side airbag device 10 according to an embodiment. The side airbag device 10 is installed in a driver seat CS of a vehicle (see the middle left part of FIG. 1). The side airbag device 10 is also referred to as a "far-side airbag device" or a "front center airbag device". FIG. 1 shows a state when the driver seat CS of a vehicle is viewed along a direction from the inside to the outside of the vehicle. In order to facilitate understanding of the technique, an outer shape of the driver seat CS is indicated by a broken line in FIG. 1.

FIG. 1 shows an upward direction UD, a downward direction DD, a forward direction FD, and a backward direction BD. The upward direction UD is an upward direction when the vehicle including the seat CS is placed on a horizontal plane. The downward direction DD is a downward direction when the vehicle including the seat CS is placed on a horizontal plane. The forward direction FD is a forward direction of the vehicle when the vehicle including the seat CS is placed on a horizontal plane. The backward direction BD is a backward direction of the vehicle when the vehicle including the seat CS is placed on a horizontal plane.

The seat CS of the vehicle includes a seat surface portion SC, a seat back SB, and a headrest HR. The seat surface portion SC is a portion that supports buttocks HP and thighs LG of an occupant OC sitting on the seat CS (see the lower part of FIG. 1). The seat back SB is a portion that supports a back BK of the occupant OC sitting on the seat CS (see the middle left part of FIG. 1). The headrest HR is a portion that supports a head HD of the occupant OC sitting on the seat CS (see the upper left part of FIG. 1).

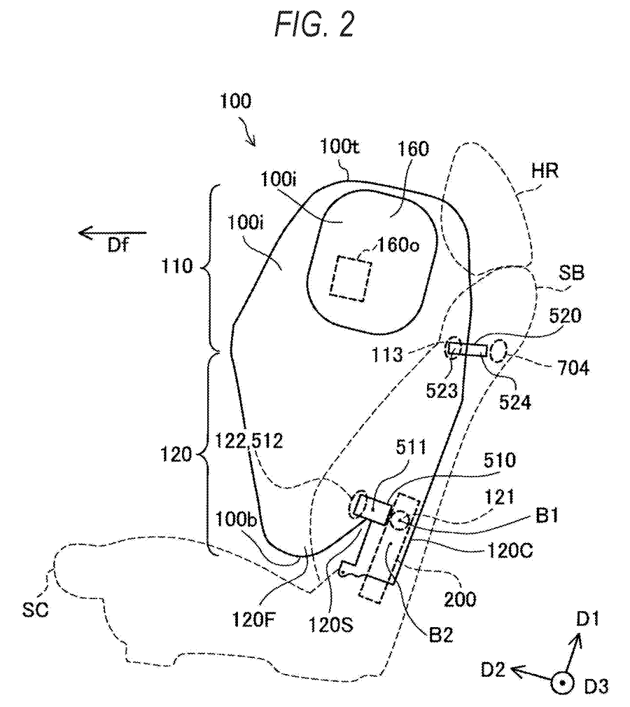

FIG. 1 shows a first direction D1, a second direction D2, and a third direction D3 orthogonal to one another. The first direction D1 is a direction in which the seat back SB extends. The second direction D2 is perpendicular to the first direction D1 and is a direction toward a side where the occupant OC sitting on the seat CS is located with respect to the seat back SB. The first direction D1, the second direction D2, and the third direction D3 constitute a right-handed system. The directions D1, D2, and D3 shown in FIGS. 2 to 9 correspond to the directions D1, D2, and D3 shown in FIG. 1.

The side airbag device 10 is disposed inside the seat back SB of the seat CS (see the middle left part of FIG. 1). More specifically, the side airbag device 10 is disposed inside a so-called side support of the seat back SB. At a center side of the vehicle, the side airbag device 10 is fixed to a side frame SF closer to the center in a left-right direction of the vehicle between a pair of side frames located in the seat back SB and extending in a longitudinal direction of the seat back SB.

The side airbag device 10 includes an airbag 100, an inflator 200, a first tether 510, a second tether 520, a case 600, and a support plate 700. In FIG. 1, the first tether 510 and the second tether 520 are not shown because the first tether 510 and the second tether 520 are covered with the case 600.

The case 600 houses the airbag 100, the inflator 200, the first tether 510, a part of the second tether 520, and the support plate 700 (see the middle left part of FIG. 1). The case 600 protects the airbag 100 from damage caused by an external force. The case 600 is made of resin.

The support plate 700 is fixed to the case 600 inside the case 600 (see the middle left part of FIG. 1). The support plate 700 holds the airbag 100 in a folded posture inside the case 600. The folded airbag 100, the inflator 200, the first tether 510, and the second tether 520 are fixed to the support plate 700. The support plate 700 is made of metal.

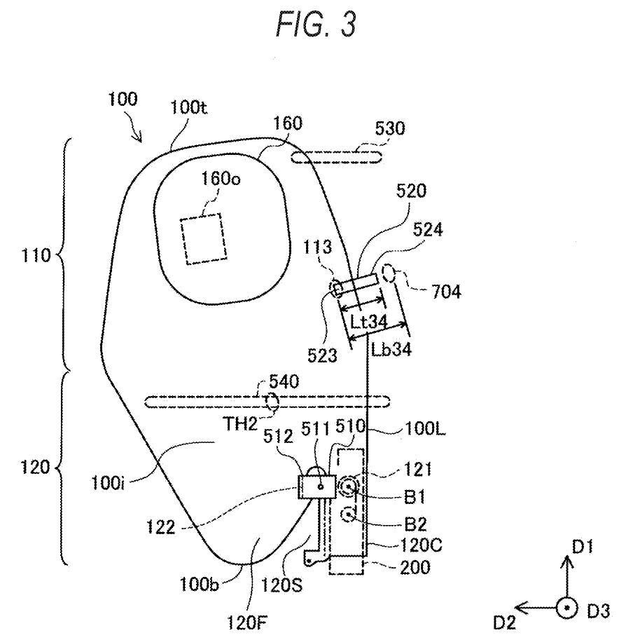

FIG. 2 is a view showing a state where the airbag 100 of the side airbag device 10 is deployed. In order to facilitate understanding of the technique, FIGS. 2 and 3 illustrate a shape of the airbag 100 in a case of assuming that the airbag 100 is deployed without the first tether 510 and the second tether 520. In FIG. 2, in order to facilitate understanding of the technique, the seat CS located in front of the deployed airbag 100 is indicated by a broken line.

The airbag 100 is housed in a folded state inside the case 600 together with the inflator 200 and the support plate 700 (see the middle right part of FIG. 1). The airbag 100 is fixed to the side frame SF of the seat back SB via the inflator 200, the support plate 700, and the case 600. As a result, the airbag 100 is fixed to the seat back SB in a folded state.

The airbag 100 includes an inflation portion 100i that inflates when supplied with a gas (see an upper central part in FIG. 2). The airbag 100 is inflated forward from the seat back SB when the inflation portion 100i is supplied with a gas. At this time, the case 600 is opened by about 60° about an axis located at a rear portion of the case 600 and substantially parallel to the first direction D1 to allow the airbag 100 to be inflated forward. In the present specification, "inflated forward" does not mean that an inflation direction is strictly parallel to the forward direction FD (see the middle right part of FIG. 1). When the inflation direction includes a component in the forward direction FD, the inflation is described as "inflated forward".

The airbag 100 includes a bag upper portion 110, a bag lower portion 120, and a sub-chamber 160. The bag upper portion 110, the bag lower portion 120, and the sub-chamber 160 are connected to one another so as to allow a gas to follow through. The bag upper portion 110 and the bag lower portion 120 are formed of one sheet.

The bag upper portion 110 is a part of the airbag 100, and includes an upper end 100t of the airbag 100 in a state where the airbag 100 is deployed (see the upper part of FIG. 2). The bag upper portion 110 has a function of protecting the vicinity of the head HD of the occupant OC in a state where the airbag 100 is deployed.

The bag lower portion 120 is another part of the airbag 100, and includes a lower end 100b of the airbag 100 in the state where the airbag 100 is deployed (see the middle part of FIG. 2). The bag lower portion 120 has a function of supporting the bag upper portion 110 at a specific position in a state where the airbag 100 is deployed. Further, the bag lower portion 120 has a function of preventing burst of the bag upper portion 110 when the bag lower portion 120 and the bag upper portion 110 are supplied with a gas delivered from the inflator 200 for a certain period of time. In the present specification, the upper end 100t and the lower end 100b are determined in a state where the seat back SB is disposed in a posture in which the first direction D1 coincides with the upward direction UD.

The sub-chamber 160 is connected to the bag upper portion 110 via a communication hole 160o (see the upper central part of FIG. 2). The gas supplied from the inflator 200 is supplied to the sub-chamber 160 via the bag lower portion 120, the bag upper portion 110, and the communication hole 160o.

The bag lower portion 120 includes a tubular portion 120C, a facing portion 120F, and a slit 120S.

The tubular portion 120C is a portion into which a part of the inflator 200 is inserted (see the lower central part of FIG. 2). The inflator 200 is bound by a band together with the tubular portion 120C from the outside of the tubular portion 120C. In order to facilitate understanding of the technique, the band is not shown in FIG. 2.

The facing portion 120F is a portion that faces the tubular portion 120C in a state where the airbag 100 is disposed in a planar shape (see the lower central part of FIG. 2). The facing portion 120F and the tubular portion 120C face each other in the second direction D2 with the slit 120S provided in the airbag 100 interposed therebetween.

The inflator 200 is fixed to the side frame SF of the seat back SB (see the lower central part of FIG. 2 and the lower central part of FIG. 1). The inflator 200 has a metal outer shell. The side frame SF is made of metal. The inflator 200 includes bolts B1 and B2. The inflator 200 is fixed to the support plate 700, the case 600, and the side frame SF of the seat back SB by the bolts B1 and B2 and nuts combined with the bolts B1 and B2.

The inflator 200 is fixed to the airbag 100 by the band in a state where a part of the inflator 200 is inserted into the tubular portion 120C of the airbag 100. The inflator 200 supplies a gas into the airbag 100. More specifically, the inflator 200 supplies a gas into the airbag 100 in response to reception of a signal from an electronic control unit (ECU) of the vehicle via a harness.

The airbag 100 includes a first bag portion 121 and a second bag portion 122 in the bag lower portion 120.

The first bag portion 121 is a portion fixed to the seat back SB (see the lower right part of FIG. 2). The first bag portion 121 is located in the tubular portion 120C of the airbag 100. More specifically, the first bag portion 121 is a portion of the bag lower portion 120 including a hole through which the bolt B1 of the inflator 200 passes. The first bag portion 121 is fixed to the support plate 700, the case 600, and the side frame SF of the seat back SB by the bolt B1 of the inflator 200 and a corresponding nut. As a result, the first bag portion 121 is disposed between the inflator 200 and the side frame SF, and is fixed to the side frame SF together with the inflator 200.

The second bag portion 122 is located in the facing portion 120F of the airbag 100 (see the lower central part of FIG. 2). The second bag portion 122 is displaced in the direction D2 away from the first bag portion 121 as the airbag 100 is inflated. The airbag 100 does not include the inflation portion 100i but includes the slit 120S, in a section between the first bag portion 121 and the second bag portion 122.

The first tether 510 and the second tether 520 restrict a shape of the airbag 100 when the airbag 100 is inflated (see the lower central part and an upper right part of FIG. 2).

FIG. 3 is a view showing a relationship between the airbag 100, and the first tether 510 and the second tether 520. The inflation portion 100i of the airbag 100 is formed by sewing a part of an outer edge of a sheet folded in a planar shape so as to face each other. Of an outer edge of the airbag 100, a linear outer edge portion 100L located at a lower right in FIG. 3 is a folded portion. Of the outer edge of the airbag 100, an outer edge portion other than the linear outer edge portion 100L is a sewn portion. The sewn portion of the outer edge of the airbag 100 includes a non-inflation portion 100n, which is not inflated, outside a sewing line. An inner surface of the inflation portion 100i is coated with silicone resin.

In order to facilitate understanding of the technique, FIGS. 2 and 3 show a state where a first tether portion 511 located at an end portion of the first tether 510 is not attached to the airbag 100. Similarly, in order to facilitate understanding of the technique, FIGS. 2 and 3 show a state where a fourth tether portion 524 located at an end portion of the second tether 520 is not attached to the support plate 700.

The first tether 510 and the second tether 520 are disposed between the airbag 100 and the side frame SF in the third direction D3. In other words, the first tether 510 and the second tether 520 are located between the airbag 100 and the occupant OC in the third direction D3. The first tether 510 and the second tether 520 are formed by stacking and joining a plurality of cloths constituting the airbag 100.

The first tether 510 is attached to the bag lower portion 120 (see the lower central part of FIG. 3). The first tether 510 includes the first tether portion 511 and a second tether portion 512.

The first tether portion 511 is a portion of the first tether 510 that is fixed to the first bag portion 121 of the airbag 100 (see the lower right part of FIG. 3). More specifically, the first tether portion 511 is a portion of the first tether 510 including a hole through which the bolt B1 of the inflator 200 passes. The first tether portion 511 is fixed to the support plate 700, the case 600, and the side frame SF of the seat back SB when the bolt B1 passes through the hole of the first tether portion 511 and is tightened by a nut. That is, the first tether portion 511 is fixed to the first bag portion 121 of the airbag 100 by the bolt B1 of the inflator 200 and the corresponding nut. The first tether portion 511 is disposed between the first bag portion 121 of the airbag 100 and the support plate 700.

In such a configuration, the first bag portion 121 is fixed to the side frame SF of the seat back SB while being interposed between the side frame SF which is a rigid body and the inflator 200 which is a rigid body. Therefore, when the airbag 100 is deployed, a position of the first bag portion 121 is less likely to move. As a result, shape transition of the airbag 100 when the airbag 100 is deployed is accurately controlled.

The second tether portion 512 is a portion of the first tether 510 that is fixed to the second bag portion 122 of the airbag 100 (see the lower central part of FIG. 3). More specifically, the second tether portion 512 is fixed to the second bag portion 122 of the airbag 100 by sewing.

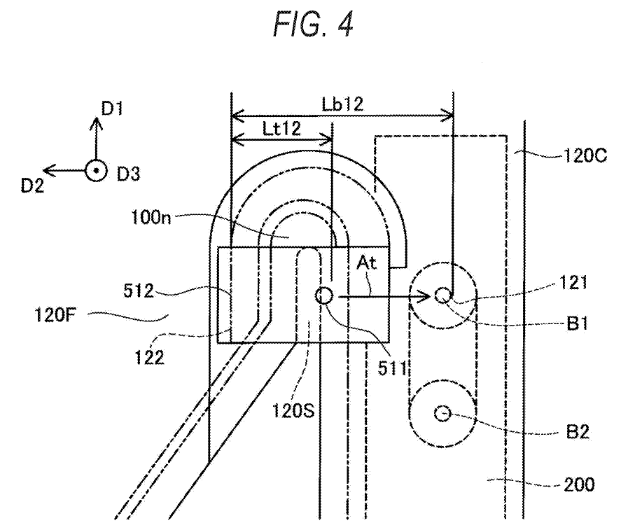

FIG. 4 is an enlarged view showing the vicinity of the first tether 510. The first tether portion 511 of the first tether 510 is fixed to the support plate 700, the case 600, and the side frame SF of the seat back SB when the bolt B1 passes through the hole of the first tether portion 511 and is tightened by a nut (see an arrow At in FIG. 4). However, in order to facilitate understanding of the technique, FIG. 4 shows a state where the first tether portion 511 is not attached to the bolt B1 of the inflator 200. In FIG. 4, a sewn portion of the airbag 100 is indicated by a two-dot chain line.

The first tether 510 is disposed between the airbag 100 and the side frame SF in the third direction D3. The second tether portion 512 of the first tether 510 is sewn to the non-inflation portion 100n located at an outer edge of the facing portion 120F.

A distance Lt12 between the first tether portion 511 and the second tether portion 512 in a state where the first tether 510 is disposed in a planar shape is smaller than a distance Lb12 between the first bag portion 121 and the second bag portion 122 in a state where the airbag 100 is disposed in a planar shape (see the upper central part of FIG. 4). The bolt B1 passes through the first tether portion 511 of the first tether 510 in a state where the airbag 100 is bent, and a position of the first tether portion 511 is fixed by a nut (see an arrow At in FIG. 4). The airbag 100 and the first tether 510 are configured such that the second bag portion 122, the second tether portion 512, the first bag portion 121, and the first tether portion 511 are positioned inside the seat back SB in a state where the airbag 100 is deployed (see the lower right part of FIG. 2).

With such a configuration, when the airbag 100 is deployed, displacement of the second bag portion 122 in the direction D2 away from the first bag portion 121 is restricted by the first tether 510 (see the lower central part of FIG. 2). As a result, when the airbag 100 is deployed, the airbag 100 is deployed at a stable position and in a stable shape without swinging violently back and forth. When the airbag 100 is deployed, the airbag 100 is bent across the slit 120S and the non-inflation portion 100n that is not the inflation portion 100i. As a result, a shape of the airbag 100 at the time of deployment is curved.

In a state where the airbag 100 is deployed, the second bag portion 122, the second tether portion 512, the first bag portion 121, and the first tether portion 511 are positioned inside the seat back SB (see the lower right part of FIG. 2). Therefore, a portion of the first tether 510 that restricts a distance between the first bag portion 121 and the second bag portion 122 is also positioned inside the seat back SB and does not come into contact with the occupant OC. Therefore, when the airbag 100 is deployed, a possibility that the airbag 100 is deployed with an unexpected shape transition due to movement of the occupant OC is reduced.

In the present embodiment, the airbag 100 includes the bag upper portion 110 and the bag lower portion 120. The first bag portion 121 and the second bag portion 122 to which the first tether 510 is fixed are provided in the bag lower portion 120 of the airbag 100 (see the lower part of FIG. 2 and the lower part of FIG. 3). With such a configuration, the vicinity of the head HD of the occupant OC can be effectively protected by the bag upper portion 110 of the airbag 100. On the other hand, an upper body UB of the occupant OC including the head HD can be appropriately protected by controlling the shape of the airbag 100 at the time of deployment without impairing a function of protecting the vicinity of the head HD of the occupant OC by the bag lower portion 120 of the airbag 100.

The airbag 100 includes a third bag portion 113 in the bag upper portion 110 of the airbag 100 (see the middle right part of FIG. 3). The third bag portion 113 of the airbag 100 is a portion to which the second tether 520 is fixed. The third bag portion 113 of the airbag 100 is included in a range in which the shoulder of the occupant OC is assumed to be located in the first direction D1.

The second tether 520 includes a third tether portion 523 and a fourth tether portion 524. The third tether portion 523 is a portion fixed to the third bag portion 113 in the bag upper portion 110 (see the middle right part of FIG. 2). More specifically, the third tether portion 523 is fixed to the third bag portion 113 of the airbag 100 by sewing.

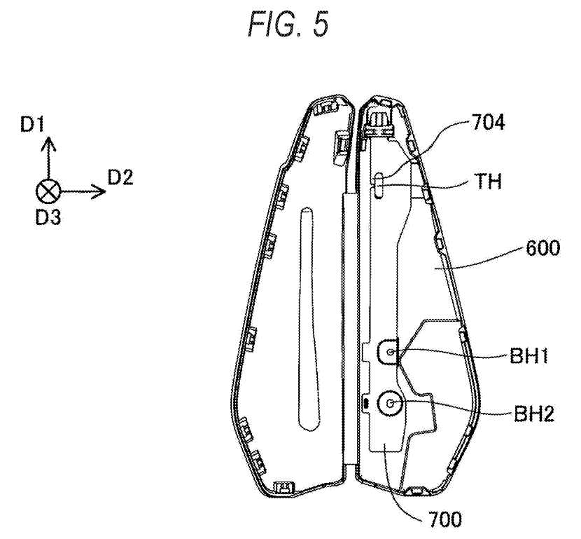

FIG. 5 is a view showing the case 600 and the support plate 700. In order to facilitate understanding of the technique, FIG. 5 shows the case 600 in a state of being opened by 180°. The case 600 includes bolt holes BH1 and BH2 and a tether hole TH. The bolt holes BH1 and BH2 are holes through which the bolts B1 and B2 of the inflator 200 pass (see the lower central part of FIG. 5). The tether hole TH is a hole through which the second tether 520 passes (see the upper central part of FIG. 5). An outer edge of the tether hole TH is not closed, and a part of the outer edge of the tether hole TH is open to the outside. The second tether 520 passes through the tether hole TH of the case 600, and the fourth tether portion 524 formed in an annular shape is locked to the outer edge of the tether hole TH of the support plate 700. The outer edge of the tether hole TH at the support plate 700 to which the annular fourth tether portion 524 is fixed is referred to as a tether fixing portion 704.

The fourth tether portion 524 is fixed to the tether fixing portion 704 of the support plate 700 (see the middle right part of FIG. 2). The support plate 700 is fixed to the side frame SF via the case 600. Therefore, the fourth tether portion 524 of the second tether 520 is fixed to the side frame SF via the support plate 700 and the case 600.

A distance Lt34 between the third tether portion 523 and the fourth tether portion 524 in a state where the second tether 520 is disposed in a planar shape is smaller than a distance Lb34 between the third bag portion 113 and the tether fixing portion 704 in a case of assuming that the airbag 100 is deployed without the second tether 520 (see the middle right part of FIG. 3). The airbag 100 and the second tether 520 are configured such that the third bag portion 113 and the third tether portion 523 are positioned inside the seat back SB in a state where the airbag 100 is deployed (see a middle right part of FIG. 2).

With such a configuration, when the airbag 100 is deployed, the displacement of the bag upper portion 110 of the airbag 100 with respect to the side frame SF is restricted by the second tether 520. Therefore, when the airbag 100 is deployed, the airbag 100 is deployed at a stable position and in a stable shape without swinging violently back and forth.

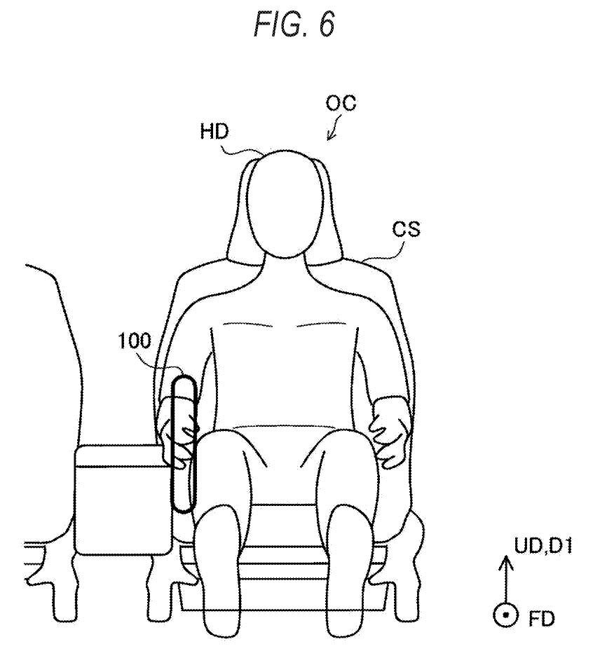

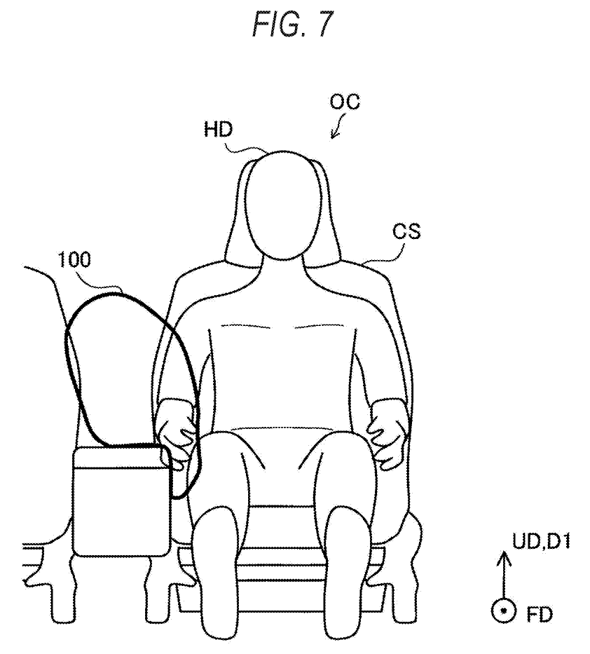

FIGS. 6 to 9 are views showing shape transition of the airbag 100 when the airbag 100 is deployed. When the inflator 200 receives a signal from the ECU of the vehicle, the inflator 200 starts supplying a gas to the airbag 100. Then, the airbag 100 protrudes forward from a side surface near a side support of the seat CS (see FIG. 6). Thereafter, the airbag 100 is inflated in the upward direction UD and toward a passenger seat (see FIG. 7). At this stage, an upper end of the airbag 100 reaches the vicinity of an upper end of a range in which the shoulder of the occupant OC is assumed to be located.

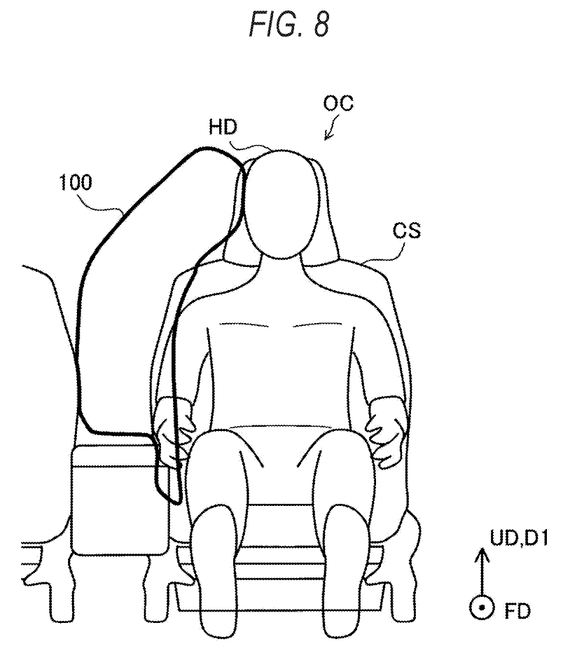

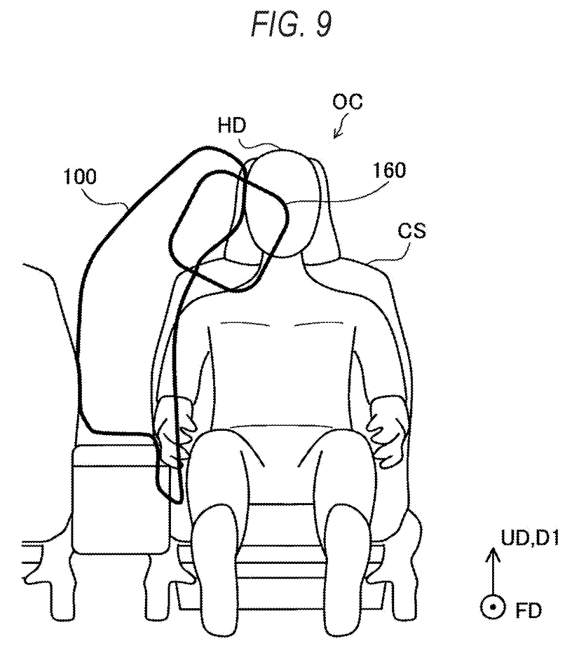

Thereafter, the bag upper portion 110 and the bag lower portion 120 of the airbag 100 are inflated so as to surround the occupant OC in a curved shape toward the occupant OC while the bag upper portion 110 and the bag lower portion 120 are restricted in inflation by the first tether 510 and the second tether 520 (see FIG. 8). At this stage, the bag upper portion 110 and the bag lower portion 120 are almost completely inflated. The upper end of the airbag 100 reaches a range in which the head HD of the occupant OC is assumed to be located. Finally, the sub-chamber 160 is inflated (see FIG. 9).

As described above, in the present embodiment, when the airbag 100 is deployed, the first tether 510 and the second tether 520 allow the airbag 100 to be deployed with a stable shape transition without causing the airbag 100 to swing violently. In the present embodiment, when the airbag 100 is deployed, the first tether 510 and the second tether 520 in the seat back SB allow the airbag 100 to be deployed with a stable shape transition without causing the airbag 100 to be deployed with an unexpected shape transition due to movement of the occupant OC.

In the present embodiment, the first tether 510 is also referred to as a "tether". The second tether 520 is also referred to as an "additional tether". The side frame SF is also referred to as a "frame". The bag upper portion 110 is also referred to as an "upper portion". The bag lower portion 120 is also referred to as a "lower portion".

### B. Other Embodiments

### B1. Other Embodiment 1

(1) In the above embodiment, the first tether portion 511 is fixed to the support plate 700, the case 600, and the side frame SF of the seat back SB when the bolt B1 passes through the hole of the first tether portion 511 and is tightened by a nut (see the arrow At in FIG. 4). Alternatively, the first tether portion 511 may be sewn and/or bonded to a portion of the non-inflation portion 100n of the airbag 100 that is directly or indirectly fixed to the side frame SF.

(2) In the above embodiment, the side airbag device 10 includes the first tether 510 and the second tether 520 (see the lower central part and the upper right part of FIG. 2). A tether including the first tether 510 and the second tether 520 restricts the shape of the airbag 100 when the airbag 100 is inflated. Alternatively, the side airbag device 10 may include another tether.

The side airbag device 10 may include, as another tether, a third tether 530 disposed between the upper end 100t of the airbag 100 and the second tether 520 in the first direction D1 (see the upper right part of FIG. 3). The third tether 530 is fixed to the bag upper portion 110 and the side frame SF of the seat back SB. The third tether 530 is disposed between the airbag 100 and the side frame SF in the third direction D3. In other words, the third tether 530 is located between the airbag 100 and the occupant OC in the third direction D3.

A distance between a fixing portion of the third tether 530 to the bag upper portion 110 and a fixing portion of the third tether 530 to the side frame SF is smaller than a distance between a portion of the bag upper portion 110 to which the third tether 530 is fixed and a portion of the side frame SF to which the third tether 530 is fixed when the airbag 100 is deployed without the third tether 530. The distance between the fixing portion of the third tether 530 to the bag upper portion 110 and the fixing portion of the third tether 530 to the side frame SF is measured in a state where the third tether 530 is disposed in a planar shape. The airbag 100 and the third tether 530 are configured such that the third tether 530 is positioned inside the seat back SB when the airbag 100 is deployed.

The side airbag device 10 may include, as another tether, a fourth tether 540 disposed between the first tether 510 and the second tether 520 in the first direction D1 (see the middle right part of FIG. 3). The fourth tether 540 is fixed to the bag lower portion 120 and the side frame SF of the seat back SB. The fourth tether 540 is disposed in the airbag 100 in a manner of passing through a hole TH2 provided in the airbag 100. In a state where the airbag 100 is deployed, a rear portion of the fourth tether 540 is disposed on a surface of the airbag 100 at a side where the occupant OC is located. A front portion of the fourth tether 540 is disposed on a surface of the airbag 100 opposite to the surface where the occupant OC is located.

A distance between a fixing portion of the fourth tether 540 to the bag lower portion 120 and a fixing portion of the fourth tether 540 to the side frame SF is smaller than a distance between a portion of the bag lower portion 120 to which the fourth tether 540 is fixed and a portion of the side frame SF to which the fourth tether 540 is fixed when the airbag 100 is deployed without the fourth tether 540. The distance between the fixing portion of the fourth tether 540 to the bag lower portion 120 and the fixing portion of the fourth tether 540 to the side frame SF is measured in a state where the fourth tether 540 is disposed in a planar shape. The airbag 100 and the fourth tether 540 are configured such that the fourth tether 540 is positioned inside the seat back SB when the airbag 100 is deployed.

With such a configuration, the first tether 510 in the seat back SB and the third tether 530 and/or the fourth tether 540 can prevent the airbag 100 from jumping upward when the airbag 100 is deployed. Further, when the airbag 100 is deployed, the airbag is deployed with stable shape transition without being deployed with an unexpected shape transition of the airbag caused by movement of the occupant OC.

The distance between the fixing portion of the fourth tether 540 to the bag lower portion 120 and the fixing portion of the fourth tether 540 to the side frame SF may be equal to the distance between the portion of the bag lower portion 120 to which the fourth tether 540 is fixed and the portion of the side frame SF to which the fourth tether 540 is fixed when the airbag 100 is deployed without the fourth tether 540.

The airbag 100 and the third tether 530 may be configured such that at least a part of the third tether 530 and/or at least a part of the fourth tether 540 is positioned outside the seat back SB in a state where the airbag 100 is deployed.

(3) In the above embodiment, the first tether 510 and the second tether 520 are formed by stacking and joining a plurality of cloths constituting the airbag 100. Alternatively, the first tether 510 and the second tether 520 may be made of a material different from the cloth constituting the airbag 100. However, the Young's modulus of the tether in a longitudinal direction is preferably larger than the Young's modulus of the cloth constituting the airbag in a surface direction.

(4) In the above embodiment, the airbag 100 does not include the inflation portion 100i but includes the slit 120S, in a section between the first bag portion 121 and the second bag portion 122 (see FIG. 4). Alternatively, the airbag 100 may not include the slit 120S, and may include the non-inflation portion 100n that is not inflated and is a portion located between two portions of the inflation portion 100i disposed facing each other.

(5) In the above embodiment, the airbag 100 does not include the inflation portion 100i but includes the slit 120S, in a section between the first bag portion 121 and the second bag portion 122 (see the middle central part of FIG. 4). Alternatively, the airbag 100 may not include the inflation portion 100i in the whole section between the first bag portion 121 and the second bag portion 122. For example, the first tether 510 may be fixed to ends of two portions of the airbag 100 facing each other with the slit 120S interposed therebetween.

(6) In the above embodiment, the airbag 100 includes the sub-chamber 160 (see the upper central part of FIG. 2 and the upper central part of FIG. 9). Alternatively, the airbag 100 may not include the sub-chamber 160.

(7) In the side airbag device according to the above embodiment, sewn portions may be fixed to one another by adhesion or welding instead of sewing.

(8) In the above embodiment, the side airbag device 10 is installed in the driver seat CS of the vehicle (see FIG. 1). Alternatively, the side airbag device 10 may be installed in a seat in a second or third row from the front. However, the side airbag device 10 is preferably installed in a seat for one person.

(9) In the above embodiment, the distance Lt34 between the third tether portion 523 and the fourth tether portion 524 in a state where the second tether 520 is disposed in a planar shape is smaller than the distance Lb34 between the third bag portion 113 and the tether fixing portion 704 in a case of assuming that the airbag 100 is deployed without the second tether 520 (see the middle right part of FIG. 3). Alternatively, the distance Lt34 may be equal to the distance Lb34.

(10) In the above embodiment, the airbag 100 and the second tether 520 are configured such that the third bag portion 113 and the third tether portion 523 are positioned inside the seat back SB in a state where the airbag 100 is deployed (see a middle right part of FIG. 2). Alternatively, the airbag 100 and the second tether 520 may be configured such that at least a part of the third bag portion 113 and/or at least a part of the third tether portion 523 is positioned outside the seat back SB in a state where the airbag 100 is deployed.

### B2. Other Embodiment 2

(1) In the above embodiment, the side airbag device 10 includes the inflator 200. Alternatively, the side airbag device may not include the inflator 200, and a gas for inflation may be supplied from a configuration outside the side airbag device.

(2) In the above embodiment, the first bag portion 121 is disposed between the inflator 200 and the side frame SF, and is fixed to the side frame SF together with the inflator 200 (see the middle right part of FIG. 4). Alternatively, the first bag portion 121 may be fixed to the side frame SF at a portion that does not overlap the inflator 200 when the side airbag device 10 is viewed along the third direction D3.

### B3. Other Embodiment 3

In the above embodiment, the first bag portion 121 and the second bag portion 122 to which the first tether 510 is fixed are provided in the bag lower portion 120 of the airbag 100 (see the lower part of FIG. 2 and the lower part of FIG. 3). Alternatively, at least one of the first bag portion 121 and the second bag portion 122 may be disposed in the bag upper portion 110 of the airbag 100.

### B4. Other Embodiment 4

In the above embodiment, the side airbag device 10 includes the second tether 520. Alternatively, the side airbag device 10 may include the first tether 510 and may not include the second tether 520.

The present disclosure is not limited to the embodiments described above, and may be implemented by various configurations without departing from the gist of the present disclosure. For example, technical features in the embodiments corresponding to technical features in aspects described in the summary of the invention may be replaced or combined as appropriate to solve a part or all of the above-described problems or to achieve a part or all of the above-described effects. The technical features may be appropriately deleted unless being described as necessary in the present specification.

What is claimed is:

1. A side airbag device disposed in a seat back, the side airbag device comprising:
an airbag fixed to the seat back in a folded state and configured to be inflated forward from the seat back when the airbag is supplied with a gas; and
a tether configured to restrict a shape of the airbag when the airbag is inflated, wherein
the airbag includes:
a first bag portion fixed to the seat back; and
a second bag portion displaced in a direction away from the first bag portion when the airbag is inflated,
the air bag does not include an inflation portion, which is inflated when receiving the gas, in at least a section between the first bag portion and the second bag portion,
the tether includes:
a first tether portion fixed to the first bag portion; and
a second tether portion fixed to the second bag portion,
a distance between the first tether portion and the second tether portion in a state where the tether is disposed in a planar shape is smaller than a distance between the first bag portion and the second bag portion in a state where the airbag is disposed in a planar shape, and
the airbag and the tether are configured such that the second bag portion, the second tether portion, the first bag portion, and the first tether portion are positioned inside the seat back in a state where the airbag is deployed.

2. The side airbag device according to claim 1, further comprising:
an inflator fixed to a frame of the seat back and configured to supply the gas into the airbag, wherein
the first bag portion is disposed between the inflator and the frame, and is fixed to the frame together with the inflator.

3. The side airbag device according to claim 2, wherein
the airbag includes:
an upper portion that is a part of the airbag, and includes an upper end of the airbag in a state where the airbag is deployed; and
a lower portion that is another part of the airbag, and includes a lower end of the airbag in the state where the airbag is deployed, and
the first bag portion and the second bag portion are provided in the lower portion.

4. The side airbag device according to claim 3, further comprising:
an additional tether configured to restrict a shape of the airbag when the airbag is inflated, wherein
the additional tether includes:
a third tether portion fixed to a third bag portion in the upper portion; and
a fourth tether portion fixed to the frame, and
a distance between the third tether portion and the fourth tether portion in a state where the additional tether is disposed in a planar shape is equal to or smaller than a distance between the third bag portion and a portion of the frame where the fourth tether portion is to be fixed in a case of assuming that the airbag is deployed without the additional tether.
